(19) United States
(12) Patent Application Publication
(10) Pub. No.: US 2008/0201558 A1
(43) Pub. Date: Aug. 21, 2008

(54) PROCESSOR SYSTEM

(76) Inventor: Soichiro HOSODA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/030,474

(22) Filed: Feb. 13, 2008

(30) Foreign Application Priority Data
Feb. 15, 2007 (JP) 2007-035353

(51) Int. Cl. G06F 9/30

(52) U.S. Cl. 712/220; 712/E09.016

(57) ABSTRACT

A processor system according to an aspect of the present invention has a pipeline. The pipeline includes a cache memory, an instruction fetch buffer which stores commands, an execution module which requests data access to the cache memory, a tag memory which outputs information related to the data access of the execution module, and an arbitration circuit which arbitrates access to the cache memory based on entry information of the instruction fetch buffer and the information related to the data access from the tag memory.

### CROSS-REFERENCE TO RELATED APPLICATIONS

This application is based upon and claims the benefit of priority from prior Japanese Patent Application No. 2007-035353, filed Feb. 15, 2007, the entire contents of which are incorporated herein by reference.

### BACKGROUND OF THE INVENTION

1. Field of the Invention

The present invention relates to a processor system that stores instruction codes and processed data in a unified cache memory and performs arbitration when a plurality of accesses conflict with one another in a pipeline operation of the processor.

2. Description of the Related Art

Conventionally, in the case where a plurality of requests for a unified cache memory, such as instruction fetch, data load, and data store, are simultaneously made, these plurality of requests are controlled by an arbitration policy that does not take into account instruction fetch to pipeline and a cache memory hit or miss. The arbitration policy by the unified cache memory architecture is disclosed in Jpn. Pat. Appln. KOKAI Publication No. 2002-539509. However, by this control, requests for the instruction fetch is temporarily stopped, and therefore, invalid instruction is supplied to the pipeline and performance of the processor is degraded.

### BRIEF SUMMARY OF THE INVENTION

A processor system according to an aspect of the present invention has a pipeline. The pipeline includes a cache memory, an instruction fetch buffer which stores commands, an execution module which requests data access to the cache memory, a tag memory which outputs information related to the data access of the execution module, and an arbitration circuit which arbitrates access to the cache memory based on entry information of the instruction fetch buffer and the information related to the data access from the tag memory.

### BRIEF DESCRIPTION OF THE SEVERAL VIEWS OF THE DRAWING

FIG. 1 is a diagram illustrating a conventional example of a pipeline operation;

FIG. 2 is a diagram illustrating an example of the pipeline operation;

FIG. 3 is a diagram illustrating a processor system;

FIG. 4 is a diagram illustrating the pipeline operation during cache refill;

FIG. 5 is a diagram comparing the conventional example with the example for pipeline efficiency;

FIG. 6 is a diagram illustrating the pipeline operation when three accesses are generated;

FIG. 7 is a diagram illustrating the pipeline operation when three accesses are generated;

FIG. 8 is a diagram illustrating the pipeline operation when three accesses are generated; and

FIG. 9 is a diagram illustrating the pipeline operation when three accesses are generated.

### DETAILED DESCRIPTION OF THE INVENTION

A processor system of an aspect of the present invention will be described below in detail with reference to the accompanying drawing.

In the present example, there is shown an application example of the present invention in a processor which carries out 5-stage pipeline (instruction fetch/decode/execute/memory access/write back [F/D/E/M/W]) operations.

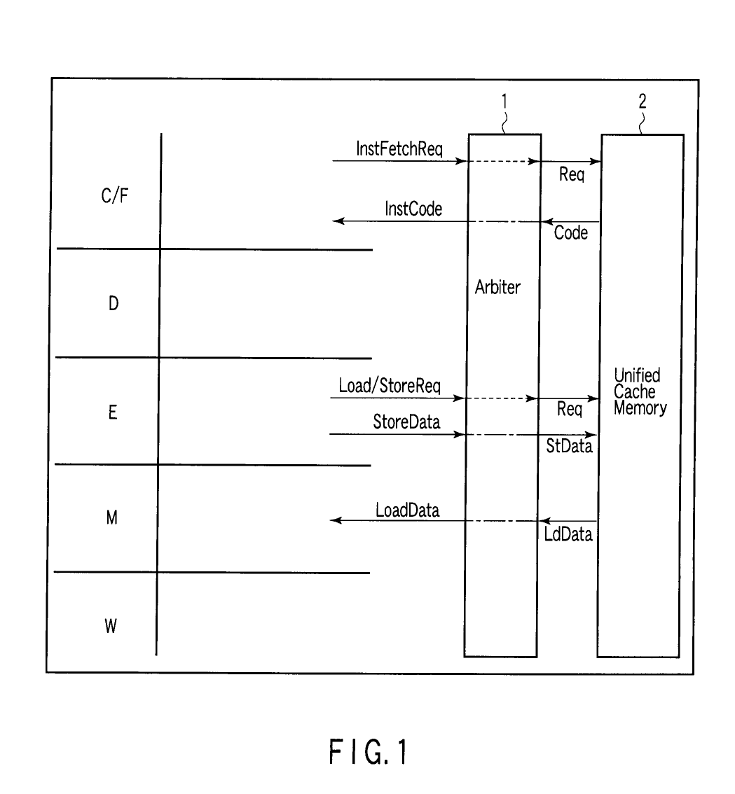

FIG. 1 illustrates the pipeline operation of a conventional processor system having the unified cache memory. In FIG. 1, a unified cache memory 2 is connected to the 5-stage pipeline (C/F, D, E, M, and W) via an arbitration circuit (arbiter) 1.

Suppose that during the pipeline operation shown in FIG. 1, instruction fetch request (Inst Fetch Req) which is a memory access from the instruction fetch stage (F-stage) and data load/store request (Load/Store Req) which is a memory access from the execute stage (E-stage) conflict with each other and the arbiter 1 chooses the load/store request from the E-stage. In such event, unless a valid instruction code is stored in an instruction fetch buffer of the F-stage, an invalid instruction (bubble) flows to the decode stage (D-stage) from the next cycle.

On the other hand, in the case where the arbiter 1 adopts the Inst Fetch Req and makes the Load/Store Req of the E-stage stand by, even if a valid instruction code is stored in the instruction fetch buffer of the F-stage, pipeline stall arising from non-execution of load/store of the subsequent stage occurs and processing of the pipeline is retard.

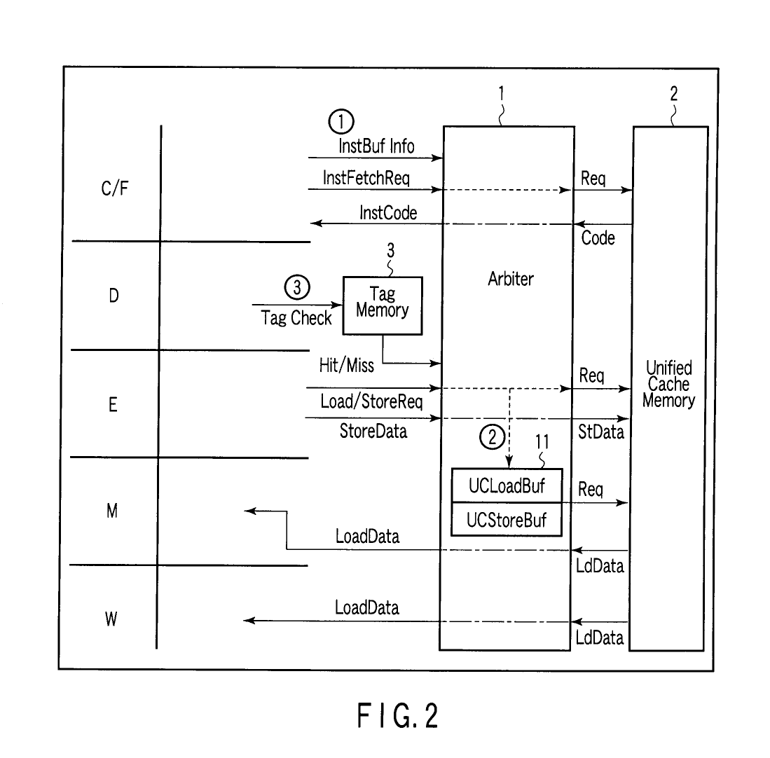

FIG. 2 illustrates the pipeline operation of a processor system having the unified cache memory according to the present example. In this example, by the pipeline configuration as shown in FIG. 2, both of the following problems are solved; namely, depletion of valid instruction codes in the instruction fetch buffer due to selecting the Load/Store Req and stall arising from stand-by of the Load/Store Req caused by selecting the Inst Fetch Req. Note that, in the present example, a load request and a store request are treated equally.

In FIG. 2, the unified cache memory 2 is connected to the 5-stage pipeline (F, D, E, M, and W) via the arbiter 1. The arbiter 1 is equipped with a Load/Store buffer (UCLoadBuf/UCStoreBuf [UCLB/UCSB]) 11. In addition, a tag memory 3 is installed on the path from the decode stage (D-stage) to the arbiter 1.

First of all, basic operations of the instruction fetch and data load/store and the definition of the unified cache memory will be described. In the 5-stage pipeline in the present example, the subsequent stages after the F-stage and the D-stage operate independently.

Furthermore, as described later, by having the instruction fetch buffer that can store a plurality of instructions in the F-stage, even if the stages after the D-stage are stopped due to pipeline stall, it is possible to execute instruction fetch in advance. In the instruction fetch for the unified cache memory 2, a request is issued from the preceding stage (C-stage in this case) of the F-stage and the instruction code is supplied in the F-stage.

On the other hand, for Load/Store Req to the unified cache memory 2, a request is issued in the E-stage, and at the time of cache-hit, in the memory stage (M-stage), execution of load data acquisition and data store for memory are achieved.

The unified cache memory 2 is unable to simultaneously accept instruction codes and Inst Fetch Req for the data storage unit and Load/Store Req. However, as described later, since tag memory areas (to judge hit and miss) for the instruction fetch system and the Load/Store system are independently kept, it is possible to judge hit and miss for the access-target line in parallel. Note that, there is no case in which Load Req and Store Req are issued simultaneously from one stage.

The following items can be mentioned as big differences between the pipeline configuration according to the present example shown in FIG. 2 and the pipeline configuration according to a conventional technique.

(1) A path to transmit the valid code storage condition of the instruction fetch buffer in the F-stage to the arbiter 1.

(2) A buffer (UCLB/UCSB) 11 to hold Load/Store Req in stand-by. That is, load request buffer for the unified cache memory 2 (unified cache memory load request buffer [UCLB])+store request buffer for the unified cache memory 2 (unified cache memory store request buffer [UCSB]).

(3) A path that accesses the tag memory 3 from the D-stage and transmits hit/miss information to the arbiter 1.

The path of Item (1) exists to implement arbitration to prevent a bubble from flowing in the pipeline by notifying the arbiter 1 that no valid entry exists in the instruction fetch buffer and instructions are depleted.

The UCLB/UCSB of Item (2) exists to hold Load/Store Req without generating pipeline stall when Load/Store Req in the E-stage conflicts with Inst Fetch Req.

The path of Item (3) notifies the arbiter 1 of hit/miss information of Load/Store Req which reached the E-stage by accelerating by one stage the access to the tag memory conducted simultaneously with the access to the unified cache memory 2 in the conventional technique.

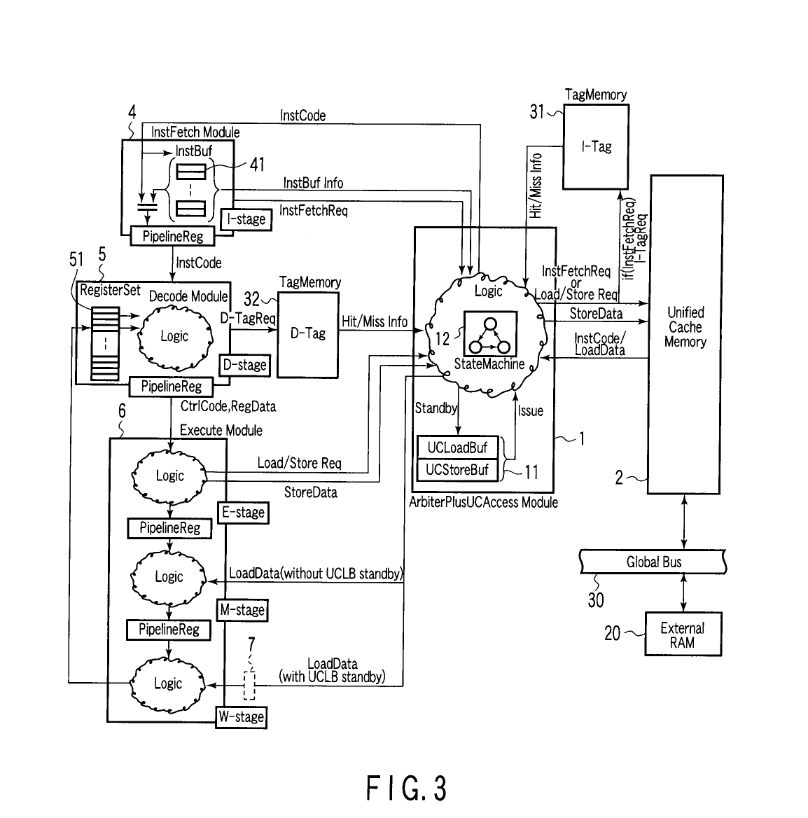

FIG. 3 illustrates a mounted example of the pipeline of the present example including the above three architectural features.

In FIG. 3, there exist three areas of the unified cache memory 2, tag memory (I-tag) 31 and tag memory (D-tag) 32. Note that, it is not always necessary to divide the tag memory into instruction code (I-tag) and data code (D-tag) to mount. That is, it is possible to mount I-tag and D-tag by different tag memories and it is also possible to divide areas on the same tag memory and mount I-tag and D-tag.

The unified cache memory 2 stores the I-tag proper and Load/Store target data proper. The tag memories 31 and 32 store tag units that correspond to each cache line. The tag memory 31 holds a tag that corresponds to an I-tag storage area and the tag memory 32 holds a tag that corresponds to Load/Store target data storage area. That is, the tag memory 3 has a 2-input/2-output configuration.

In addition, as processing modules, there exist an InstFetch module 4, Decode module 5, Execute module 6, and Arbiter Plus Unified Cache Access (APUCA) module 1.

The InstFetch module 4 holds a plurality of instruction fetch buffers (InstBuf) 41 for storing valid I-tags and is able to fetch valid I-tags from the unified cache memory 2 even when the latter stages of pipeline in and after the Decode module 5 are stalled. The Decode module 5 decodes instruction codes from the InstFetch module 4, detects Load/Store which issues a request in the Execute module 6 at some stage, carries out address computation, and accesses the D-tag 32 which controls tag information of the data storage area.

Note that, it is possible to employ an approach to give priority to InstFetch Req by storing Store Req in multiple stages of Store Req buffer (UCSB) not by the use of the hit/miss information when Data Store Req conflicts with InstFetch Req and to process Store Req in the Store Req buffer (UCSB) in a period accessible to the unified cache memory 2 (period in which no other access is present), but in this case, an approach in which advance tag access is performed together with Load/Store Req will be discussed.

The hit/miss information of Load/Store Req read from the D-tag 32 reaches the Arbiter Plus Unified Cache Access (APUCA) module 1 simultaneously with a cycle in which the request proper reaches the E-stage in the Execute module 6 and the Execute module 6 issues Load/Store Req.

A state machine 12 inside the Arbiter Plus Unified Cache Access (APUCA) module 1 performs state transition on the basis of InstFetch Req from the InstFetch module 4 and InstBuf Info inside the InstBuf 41, Load/Store Req from the Execute module 6, and Hit/Miss Info from the D-tag 32, and decides a request to be issued to the unified cache memory 2 in accordance with an arbitration policy later discussed.

The Load/Store Req rejected by the arbitration in the Arbiter Plus Unified Cache Access (APUCA) module 1 is temporarily saved in the UCLB/UCSB 11 (Standby path in the figure) to be issued to the unified cache memory 2 later. Thereafter, when a request issuance permission in the UCLB/UCSB 11 is given by the state machine 12, a request is issued from the UCLB/UCSB 11 to the unified cache memory 2 (Issue path in the figure).

A request adopted after arbitration is transmitted to the 1-input 1-output unified cache memory (memory which accepts only one request at a time) 2. In this event, when the adopted request is an InstFetch Req, access to the I-tag 31 is made simultaneously because the tag memory is not referred to in advance. The Inst Code returned from the unified cache memory 2 to the Arbiter Plus Unified Cache Access (APUCA) module 1 is returned to the InstFetch module 4 and the Load Data to the Execute module 6.

Now, when the Load Req is a request once saved by the UCLB of the UCLB/UCSB 11, the Load Data is transmitted to a write back stage (W-stage), not to a memory stage (M-stage). Depending on mounting methods, in order to avoid a critical path, it is possible to employ a method for inserting a register 7 into a path in which the Load Data is transmitted to the W-stage (a register is shown by a dotted line in the figure).

When the register 7 is inserted, data writing to a Register Set 51 of the D-stage is delayed by one-cycle, and adjustment in subsequent reading of the register value is required.

In the case where Load Req is forced to wait by conflict with InstFetch Req and access to the unified cache memory 2 is made by the use of the UCLB, Load Data arrives through the path to this W-stage. In the case where there is no conflict with InstFetch Req and Load Req is executed as usual without going through the UCLB, Load Data arrives by way of the path to the M-stage.

Next discussion will be made on the basic policy in arbitration between InstFetch Req and Load/Store Req. As the basic policy, the following items are mentioned.

(1) In the case where fetch latency can be hidden by InstBufs which exist in a plurality, priority is given to Load/Store Req.

(2) In an aspect in which the valid I-tag is depleted in InstBufs and a bubble possibly flows to the pipeline, priority is given to InstFetch Req.

(3) In the case where it is known that Load/Store Req which has reached the E-stage gives rise to a cache miss, priority is given to Load/Store Req.

In the basic policy (3) of the arbiter 1, when Load/Store Req accompanied by the cache miss conflicts with InstFetch Req (also when valid I-tag in InstBuf is depleted), Load/Store Req is given priority, the reason for which will be described as follows.

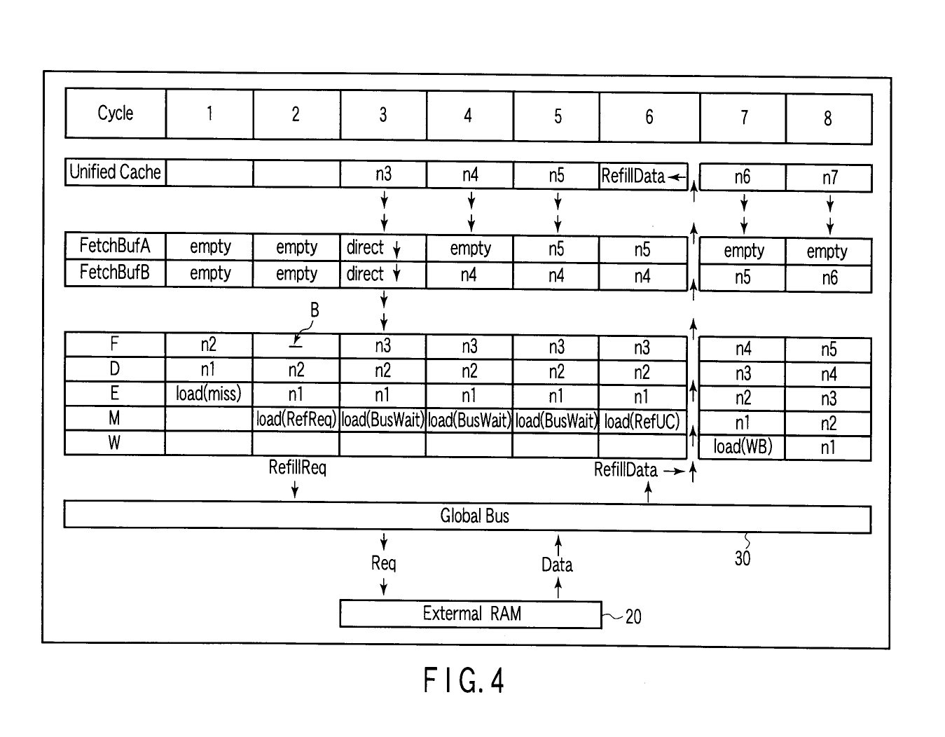

FIG. 4 is a diagram showing the pipeline operation when the cache is refilled by the technique according to the present example. FIG. 4 shows a case in which the arbiter 1 adopts Load Req when Load Req accompanied by a cache miss conflicts with InstFetch Req with valid I-tag depleted in InstBuf. To simplify description, suppose that instructions (n1-n5) after loading are not Load/Store/Branch instructions.

In FIG. 4, because InstFetch Req is forced to wait at “Cycle 1,” it is possible to confirm that a bubble B is inserted in the F-stage of “Cycle 2.” Thereafter, in and after “Cycle 3,” Load Req stalls to wait for refill from an external memory 20 in the memory stage. During this period, no memory access arising from Load to the unified cache memory 2 is generated, and therefore, the F-stage which is independent from the pipeline of subsequent stages reads a valid I-tag (n3) and exchanges the former bubble B for the valid instruction (n3) (Cycle 3).

Furthermore, while being in a refill data wait state due to bus latency, the F-stage steadily reads I-tags (n4 and n5) from the unified cache memory 2 and stores them in InstBuf (Cycles 4 and 5). Thereafter, when Refill Data is returned from an external bus 30, Refill Data is written back to the unified cache memory 2, and (in the case where a critical-word-first mechanism, etc. is applied) Load Req of the M-stage is released from stall (Cycle 6). Thereafter, based on the valid I-tags (n4 and n5) stored in InstBuf, pipeline operation is resumed (Cycles 7 and 8).

As described above, by achieving instruction fetch operation during refill operation, pipeline operation after refill can be achieved without flowing bubbles in the pipeline. Suppose the case in which Instruction Fetch is given priority in the “Cycle 1” stage. The refill start operation of Load Req is one-cycle late and the termination of Load Req is delayed from Cycle 7 to Cycle 8.

FIG. 5 is a diagram showing comparison results of the pipeline efficiency between a conventional technique and the technique according to the present example, and FIG. 5A shows the conventional technique and FIG. 5B the technique of the present example. In “Cycle 1” of FIG. 5, assume that the valid instruction in InstBuf has been already depleted.

In the conventional technique, as shown in FIG. 5A, Instruction Fetch is forced to wait in “Cycle 1” (because it is judged that a stall would occur when the subsequent Load is forced to wait), and thus the bubble B flows in the pipeline in and after “Cycle 2.” The “n3” instruction located after 3 instructions of Load Req has its processing eventually terminated in “Cycle 7.”

On the other hand, in the pipeline of the present example, as shown in FIG. 5B, Instruction Fetch is adopted in “Cycle 1” (assumed that load is hit), and Load Req is stored in the UCLB. Consequently, in “Cycle 2,” a valid instruction is supplied to the pipeline. Simultaneously (in Cycle 2), Load Req is issued from the UCLB to the unified cache memory 2 and the data is recovered in the W-stage. At the time of “Cycle 1,” it is already known that the relevant Load Req is hit, no delay occurs in and after the W-stage.

The “n3” instruction located after three instructions of Load Instruction has the processing eventually terminated in “Cycle 6.” When the bit length of InstBuf is set to be longer than the bit length of one Execution Instruction, instructions are not depleted immediately even in and after “Cycle 3.”
In “Cycle 1” of FIG. 5B, Instruction Fetch conflicts with Load Instruction of the E-stage and Instruction Fetch becomes effective, and therefore, Load Instruction is stored in the UCLB for standby. Thereafter, in “Cycle 2,” Load Req is issued from the UCLB to the unified cache memory 2 and in “Cycle 3,” Load Data is returned to Load Req of the W-stage.

In “Cycle 2” of FIG. 5B, in the case where Instruction Fetch is further generated and in the case where the “n1” instruction of the E-stage is Load Req or Store Req, three requests of 1. Instruction Fetch, 2. Request when the “n1” instruction is Load Req or Store Req, and 3. Load Req in the UCLB are generated to the unified cache memory 2.

Now, in the case where no Load Req of the UCLB is executed, no load data is obtained even if Load Req of the M-stage moves to the subsequent stage (W-stage), and therefore, Load Req stays in the M-stage and the pipeline stalls (temporarily) (F: n3, D: n2, E: n1, M: Load, and W: blank).

Thereafter, at the stage when Load Req in the UCLB is executed and Load Data is judged to be returned in the subsequent cycle, Load Instruction of the M-stage advances to the W-stage (cycle 3), and receives Load Data and completes processing.

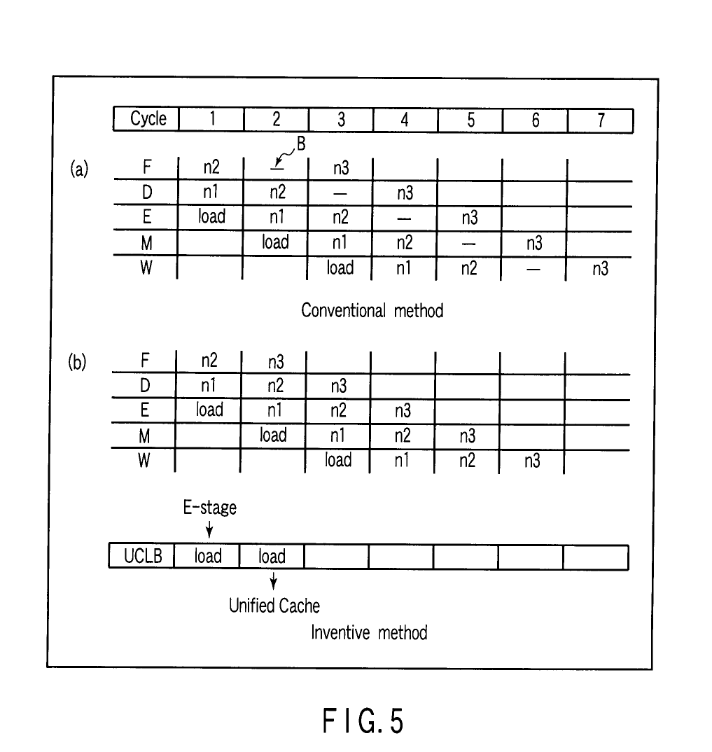

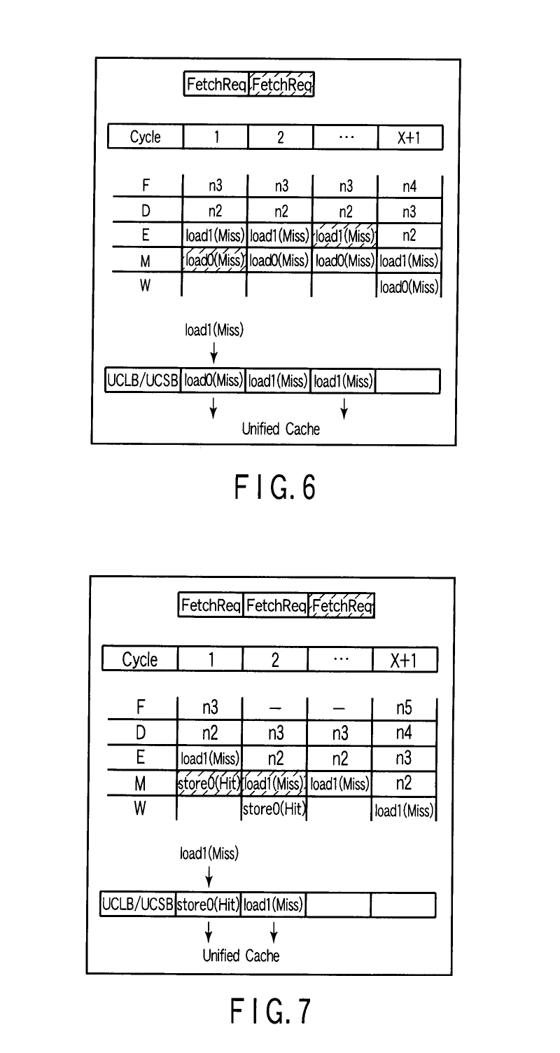

FIGS. 6 to 9 are illustrations that indicate an arbitration method when three access requests of InstFetch Req, Load/Store Req of the E-stage, and UCLB/UCSB Req in the technique of the preset example are directed to the unified cache memory 2. Note that, in FIGS. 6 to 9, the pipeline is shown in the same manner as in FIG. 5.

In the foregoing description, there has been shown a method for the arbiter 1 to arbitrate InstFetch Req and Load/Store Req with Load/Store buffer (UCLB/UCSB) 11 initially in an empty state. In what follows, an arbitration method when Load/Store Req which has been forced to wait by previous arbitration exists in the UCLB/UCSB will be described.

FIGS. 6 to 9 show the condition in which in “Cycle 1”, access requests of three parties, namely, InstFetch Req, Load/Store Req of the E-stage, and Load/Store Req whose request is stopped in the E-stage and is forced to wait in the UCLB/UCSB (Load/Store instruction of the requesting source exists in the M-stage in the pipeline) are generated to the unified cache memory 2. Note that, “−” in the figure indicates a bubble, and “n2 . . . n5” are shown as an instruction group other than Load/Store Req.

There are 2×2=4 combinations of Hit/Miss of Load/Store Req existent in the E-stage/M-stage as shown in Table 1 below.

TABLE 1

| | E-stage | M-stage |
|---|---|---|
| A | Miss | Miss |
| B | Miss | Hit |
| C | Hit | Miss |
| D | Hit | Hit |

In any of the cases of Patterns A, B, C, and D, the pipeline stalls (temporarily) unless access from Load/Store Req which is ready and waiting in the UCLB/UCSB is permitted to the unified cache memory 2. Consequently, by the policy “to give top priority to the case in which Load/Store Req exists in the UCLB/UCSB,” arbitration is conducted when three access requests are made. Note that, the shaded access requests in FIGS. 6 to 9 indicate that access to the unified cache memory 2 is possible as a result of arbitration.

In the case of FIG. 6, load 1 (Miss) following Load 0 (Miss) gives rise to Cache Miss and Refill processing using the external bus 30 is needed (as is the case of processing for an external RAM 20 of FIG. 4), and therefore, load 1 waits in the UCLB until refill processing of load 0 is finished. The external bus 30 is assumed to be occupied until load 0 refill is finished, and load 0 stays in the M-stage of the pipeline and waits for data arrival until the refill data is returned. That is, in this event, the pipeline stall occurs. The pipeline stalls because Load/Store Req exists in the M-stage and the processing data is unable to arrive even if Load/Store Req moves to the next stage (W-stage). “X” of “Cycle” in FIG. 6 depends on the refill processing time.

In the case of FIG. 7, processing of load 1 (Miss) is conducted after processing of store 0 (Hit) which is waiting in the UCSB is finished. That is, store 0 (Hit) of the M-stage is adopted and priority is given to processing of the latter stages of the pipeline. Because no InstFetch Req is made, a bubble flows in the pipeline, but conducting InstFetch by the use of a cycle which becomes blank during process of a long refill of load 1 (Miss) enables valid instructions (n4 and n5 in FIG. 7) to be embedded in the bubble in the pipeline.

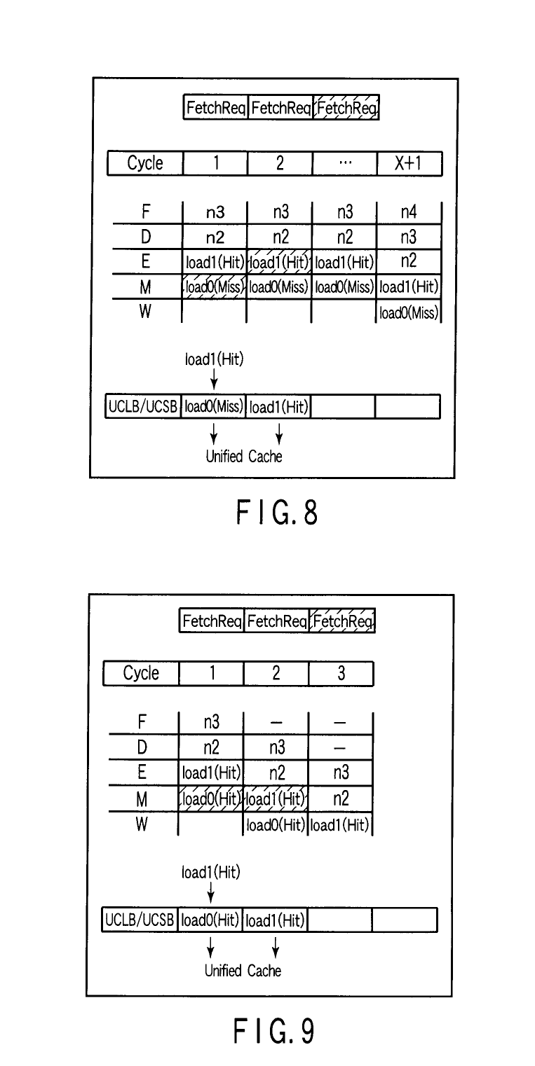

In the case of FIG. 8, the unified cache memory 2 itself becomes available in the wait cycle of refill of load 0 (Miss) which is waiting in the UCLB, and therefore, by the use of this blank cycle 2, processing of load 1 (Hit) is conducted. However, in the case where the access party of load 1 (Hit) is targeted to the line whose cache is being renewed by refill-processing of load 0 (Miss), no access is allowed and the standby state is established (operation close to standby of load 1 [Miss] of FIG. 6). Note that, load 1 (Hit) is allowed to access the unified cache memory 2 if the access party is not the line being under refill-processing of load 0 (Miss).

In the case of FIG. 9, both load 0 (Hit) and load 1 (Hit) occupy the unified cache memory 2 for one cycle and conduct processing, and therefore, there is no blank cycle, and they are processed in order of load 0→load 1→Fetch Req.

As described above, according to the present example, valid instruction processing ratio of the pipeline (pipeline efficiency) can be improved by arbitrating memory accesses generated from InstFetch side and data processing side to the unified cache memory, with consideration given to storage condition (entry information) of InstBuff in the pipeline and data access information (hit/miss information) to the cache memory.

The present invention is not be limited to the above-mentioned example only but can be practiced by suitable modification without departing from the spirit thereof. For example, the present invention can be applied not only to pipelines related to a processor system but also to various pipelines applied to semiconductor integrated circuits.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A processor system including a pipeline comprising:
a cache memory;
an instruction fetch buffer which stores commands;
an execution module which requests data access to the cache memory;
a tag memory which outputs information related to the data access of the execution module; and
an arbitration circuit which arbitrates access to the cache memory based on entry information of the instruction fetch buffer and the information related to the data access from the tag memory.

2. The processor system according to claim 1,
wherein the information related to the data access is hit/miss information of a cache line of load request or store request, and in the case where the data access which generates a cache miss is requested from the execution module to the cache memory, the hit/miss information is given priority over an instruction fetch access.

3. The processor system according to claim 2,
wherein by giving priority to the data access which generates the cache miss, the instruction fetch access is forced to wait, and as a result, in the case where any invalid instruction flows in a pipeline, the instruction fetch access is executed in a period in which the cache memory processing the cache miss arising from the data access is not used, and the invalid instruction in the pipeline is replaced with a valid instruction.

4. The processor system according to claim 3,
wherein the instruction fetch access is executed during a refill operation.

5. The processor system according to claim 1,
wherein the data access is given priority
in the case where the data access to the cache memory and an instruction fetch access generated in order to store instruction codes in the instruction fetch buffer occur simultaneously, and at the same time,
in the case where any invalid instruction is prevented from flowing in the pipeline even when the instruction fetch access is forced to wait by an instruction code existent in the instruction fetch buffer which can store the commands.

6. The processor system according to claim 1,
wherein the cache memory has a 1-input/1-output configuration for a data unit and executes only one access request at a time.

7. The processor system according to claim 1,
wherein priority is given to a load/store request in the case where fetch latency can be hidden by the instruction fetch buffer.

8. The processor system according to claim 1,
wherein in the case where valid instruction codes are depleted in the instruction fetch buffer and invalid instructions are supplied to the pipeline, an instruction fetch request is given priority.

9. The processor system according to claim 1,
wherein in the case where a load/store request which has reached an execution stage is already known to generate a cache miss, the load/store request is given priority.

10. The processor system according to claim 1,
wherein a bit length of the instruction fetch buffer is longer than a bit length of one execution instruction.

11. A semiconductor integrated circuit including a pipeline comprising:
a cache memory;
an instruction fetch buffer which stores commands;
an execution module which requests data access to the cache memory;
a tag memory which outputs information related to data access of the execution module; and
an arbitration circuit which arbitrates access to the cache memory based on entry information of the instruction fetch buffer and the information related to the data access from the tag memory.

12. The semiconductor integrated circuit according to claim 11,
wherein the information related to the data access is hit/miss information of a cache line of load request or store request, and in the case where the data access which generates a cache miss is requested from the execution module to the cache memory, the hit/miss information is given priority over an instruction fetch access.

13. The semiconductor integrated circuit according to claim 12,
wherein by giving priority to the data access which generates the cache miss, the instruction fetch access is forced to wait, and as a result, in the case where any invalid instruction flows in a pipeline, the instruction fetch access is executed in a period in which the cache memory processing the cache miss arising from the data access is not used, and the invalid instruction in the pipeline is replaced with a valid instruction.

14. The semiconductor integrated circuit according to claim 13,
wherein the instruction fetch access is executed during a refill operation.

15. The semiconductor integrated circuit according to claim 11,
wherein the data access is given priority in the case where the data access to the cache memory and an instruction fetch access generated in order to store instruction codes in the instruction fetch buffer occur simultaneously, and at the same time,
in the case where any invalid instruction is prevented from flowing in the pipeline even when the instruction fetch access is forced to wait by an instruction code existent in the instruction fetch buffer which can store the commands.

16. The semiconductor integrated circuit according to claim 11,
wherein the cache memory has a 1-input/1-output configuration for a data unit and executes only one access request at a time.

17. The semiconductor integrated circuit according to claim 11,
wherein priority is given to a load/store request in the case where fetch latency can be hidden by the instruction fetch buffer.

18. The semiconductor integrated circuit according to claim 11,
wherein in the case where valid instruction codes are depleted in the instruction fetch buffer and invalid instructions are supplied to the pipeline, an instruction fetch request is given priority.

19. The semiconductor integrated circuit according to claim 11,
wherein in the case where a load/store request which has reached an execution stage is already known to generate a cache miss, the load/store request is given priority.

20. The semiconductor integrated circuit according to claim 11,
wherein a bit length of the instruction fetch buffer is longer than a bit length of one execution instruction.
